(19) United States
(12) Patent Application Publication
(10) Pub. No.: US 2018/0060885 A1
(43) Pub. Date: Mar. 1, 2018

(54) SEGMENTATION BASED ESTIMATION METHOD FOR DEMAND MODELS UNDER CENSORED DATA

(71) Applicant: International Business Machines Corporation, Armonk, NY (US)

(72) Inventors: Adam N. Elmachtoub, New York, NY (US); Markus R. Ettl, Ossining, NY (US); Sechan Oh, New York, NY (US); Marek Petrik, Lee, NH (US); Rajesh K. Ravi, Yorktown Heights, NY (US)

(21) Appl. No.: 15/251,183

(22) Filed: Aug. 30, 2016

(51) Int. Cl. G06Q 30/02; G06Q 10/06

(52) U.S. Cl. CPC G06Q 30/0202; G06Q 10/067; G06Q 30/0204

(57) ABSTRACT

A hardware processor coupled to a transaction data database and a customer data database receives transaction data and customer data, and executes a predictive modeling algorithm that determines customer features that characterize purchasing behavior from the customer data and the transaction data. The hardware processor executes a clustering algorithm that segments customers into multiple groups based on the customer features. A likelihood function is constructed based on a selected demand model, the transaction data and customer segment information determined from the multiple groups, the likelihood function determined based on probability that each sales transaction belongs to a segment conditioned on a paid price. A model estimator computes parameters that maximize the likelihood function.

### FIELD

The present application relates generally to computers and computer applications, and more particularly to segmentation based estimation.

### BACKGROUND

Estimating customer choice model for a product, that is, the probability a specific consumer will purchase a product, requires knowledge of both consumers who purchased and those consumers who considered but did not purchase the product. In many cases, only the former is given. For instance, a user may open a web page or navigate a web site for viewing product information. While the data records for transactions that actually occurred may be stored and made available, transactions that do not occur are not usually ascertainable. More specifically, sales transaction data provides only the information about the customer who purchased the product, and thus suffers from two types of information censoring: Type 1 lost sales in which customers who were interested in the product, but did not buy because the sales price is higher than their reservation price; and type 2 lost sales in which customers who could not buy the product because the product is out-of-stock (or sold out). Even when there is extra information regarding customers (e.g., status, last login time), this information is leveraged to fit a consumer choice model with only lost sales data.

### BRIEF SUMMARY

A system and method of constructing a segmentation-based demand model estimator executable on a computer may be provided. The system, in one aspect, may include a transaction data database. The system may also include a customer data database. The system may further include a hardware processor coupled to the transaction data database and the customer data database and comprising a customer segmentation engine. The customer segmentation engine receives transaction data from the transaction data database and customer data from the customer data database. The customer segmentation engine executes a predictive modeling algorithm that determines customer features that characterize purchasing behavior from the customer data and the transaction data. The customer segmentation engine executes a clustering algorithm that segments customers into multiple groups based on the customer features. The hardware processor may also include a likelihood function constructor that selects a customer demand model and constructs a likelihood function based on the transaction data and customer segment information determined from the multiple groups. In one aspect, the likelihood function may be determined based on probability that each sales transaction belongs to a segment conditioned on a paid price. The hardware processor may also include a demand model estimator that computes parameters of the likelihood function that maximizes the likelihood function.

A method of constructing a segmentation-based demand model estimator executable on a computer, in one aspect, may include receiving transaction data from a transaction data database and customer data from a customer data database. The method may also include executing a predictive modeling algorithm that determines customer features that characterize purchasing behavior from the customer data and the transaction data. The method may further include executing a clustering algorithm that segments customers into multiple groups based on the customer features. The method may also include selecting a customer demand model. The method may also include constructing a likelihood function based on the customer demand model, the transaction data and customer segment information determined from the multiple groups, the likelihood function determined based on probability that each sales transaction belongs to a segment conditioned on a paid price. The method may further include determining parameter values of the likelihood function that maximizes the likelihood function. The method may also include executing the likelihood function with the determined parameter values.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a flow diagram illustrating a method of the present disclosure in one embodiment.

FIG. 2 is a diagram illustrating system architecture in one embodiment of the present disclosure.

FIG. 3 illustrates a schematic of an example computer or processing system that may implement a segment based estimator system in one embodiment of the present disclosure.

### DETAILED DESCRIPTION

A system and method may be provided that estimate a customer demand model with sales transaction data and customer data. The system and method in one embodiment allows a retailer system or another system to be able to determine personalized price discounts to its customers or purchasers. The system and method in one embodiment estimate demand under censored data leveraging customer segments without depending on lost information. In known systems, to determine the optimal price discounts, a retailer system considers how the purchasing probabilities of individual customers change as the sales prices change. For example, the retailer system can estimate customers' purchasing probabilities (also referred to as customer demand model) using historical sales transaction data. Examples of customer demand model includes the logistic model of the following form:

$$\frac{{e}^{α p + β}}{1 + {e}^{α p + β}}$$

where p is price, and are α and β are unknown parameters to be estimated. The estimation requires both sales and lost sales data. In practice, information on lost sales (no purchase cases) is often not recorded. For example, airline booking records do not contain information on the events in which a customer checks the price, but does not purchase a ticket, for example, because of the price.

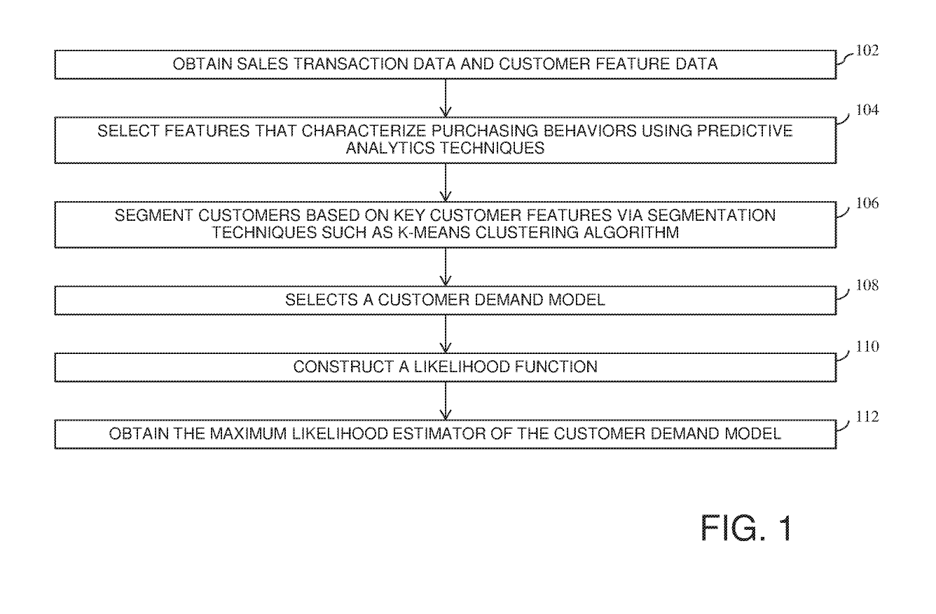

FIG. 1 is a flow diagram illustrating a method of the present disclosure in one embodiment. At 102, sales transaction data and customer feature data is obtained. Sales transaction data may be obtained from the seller's transaction record system such as booking record system. Customer features may be obtained, for example, from loyalty program system and click-stream monitoring systems.

At 104, customer features are selected that characterize purchasing behavior. Examples of such features may include but are not limited to age or age range, region, total spending, purchase frequency. Selection of customer features may be performed by implementing a predictive analytics technique. For example, a regression analysis may be performed to predict normalized average purchasing price of products using available customer features, and select features based on feature importance scores for the predictive model. An example of feature importance score includes the p-value of regression models.

At 106, customers are segmented based on the customer features selected at 104. A segmentation technique may be implemented to segment the customers. An example of a segmentation technique may include but is not limited to K-means clustering algorithm.

At 108, a customer demand model is selected. A statistical method to select a demand model may be employed by fitting the data to each demand model, and selecting the model with the smallest testing error. In another aspect, a model may be manually chosen, for example by a user. A set of preconfigured models may be provided, from which to select or choose the model. Examples of a demand model may include but are not limited to logistic model, linear model and log-linear model. For example, a probability (Prob (p|s)) that a customer belonging to segment s buys a product when the price of the product is p may be modeled as logistic demand model,

$$Prob ( pls ) = \frac{{e}^{{α}_{s} p + {β}_{s}}}{1 + {e}^{{α}_{s} p + {β}_{s}}} .$$

Another example of the model is a linear demand model, Prob (p|s)=αₛ−βₛp.

At 110, a likelihood function is constructed. For example, the likelihood function may be constructed as follows. The likelihood function may be built based on a customer segment built at 106, for example, customer segment: s={1, 2} and a customer demand model selected at 108.

From sales transaction data of size N (N number of transactions), segment of the customer of n-th sales transaction (the segment to which the customer who performed the n-th transaction belongs), s(n) may be obtained. In one embodiment, the criteria for s(n) is explicitly defined by the outcome of the segmentation performed at 106. For example, K-means clustering generates the centers (vector of customer features) of K segments, and each customer belongs to the segment whose center is the closest from its customer feature vector.

Also from the sales transaction data of size N, price paid at n-th sales transaction, p(n) may be obtained. For instance, p(n) may be retrieved directly from the transaction data.

A percentage of arrived customers who belong to segment 1 is obtained as ‘q’. ‘q’ is one of the parameters that is estimated in one embodiment. ‘q’ indicates the percentage of customers who belong to segment 1 out of all customers who considered purchasing the product.

Given paid price p, the probability that the customer belongs to segment 1 is determined as:

$$( \frac{q * Prob ( p ( n ) \vert 1 )}{q * Prob ( p ( n ) \vert 1 ) + ( 1 - q ) * Prob ( p ( n ) \vert 2 )} ) \qquad Equation ( 1 )$$

Given paid price p, the probability that the customer belongs to segment 2 is determined as:

$$( \frac{q * Prob ( p ( n ) \vert 2 )}{q * Prob ( p ( n ) \vert 1 ) + ( 1 - q ) * Prob ( p ( n ) \vert 2 )} ) \qquad Equation ( 2 )$$

Prob(p|s) represents the purchasing probability when the customer belongs to segment s and the price is p. The exact form of this probability function depends on the demand model chosen at 108, for example. Given this definition, the above formulas (Equations (1) and (2)) represent posterior probability distributions of customer segments conditioned on the paid price.

Likelihood function L is determined as

$$L = {\prod }_{n = 1}^{N} ( {( \frac{q * Prob ( p ( n ) \vert 1 )}{q * Prob ( p ( n ) \vert 1 ) + ( 1 - q ) * Prob ( p ( n ) \vert 2 )} )}^{1 ( s ( n ) = 1 )} {( \frac{q * Prob ( p ( n ) \vert 2 )}{q * Prob ( p ( n ) \vert 1 ) + ( 1 - q ) * Prob ( p ( n ) \vert 2 )} )}^{1 ( s ( n ) = 2 )} )$$

The likelihood function indicates probability that the N sales transactions are made by each corresponding customer segment conditioned on the paid prices.

In one embodiment, this likelihood function uses paid price p(n) and corresponding customer's segment s(n), and does not require any lost sales information.

At 112, the maximum likelihood estimator of the customer demand model is obtained. The maximum likelihood estimator refers to the parameter values (for example, q, α₁, β₁, α₂, β₂ of the chosen model) that maximize the likelihood function. For example, consider that there are two customer segments. Also consider that the logistic demand model is chosen as the customer demand model. Then the probability functions are given as

$$Prob ( pls ) = \frac{{e}^{{α}_{s} p + {β}_{s}}}{1 + {e}^{{α}_{s} p + {β}_{s}}}$$

for each s={1, 2}. The likelihood function is then described as the function of five parameters: q, α₁, β₁, α₂, β₂.

For sales transaction data and customer segments information, the demand model estimator or the maximum likelihood estimator determined as the optimal set of parameters that maximize the likelihood function. For instance, the parameters q, α₁, β₁, α₂, β₂ are solved for simultaneously that maximizes the likelihood function. In one embodiment, numerical methods such as gradient descent methods may be implemented to determine the optimal set of parameters.

When there are more than two customer segments, the above method may be implemented iteratively. For example, consider that three customer segments are created: 1, 2, and 3. Then, the method may merge segments 2 and 3, and execute the method at 108, 110 and 12 for segment 1 and the combined segment (2 and 3) to obtain the maximum likelihood estimator for segment 1. Next, the method at 108, 110 and 112 may be executed for segments 2 and 3 to obtain the estimators for segments 2 and 3.

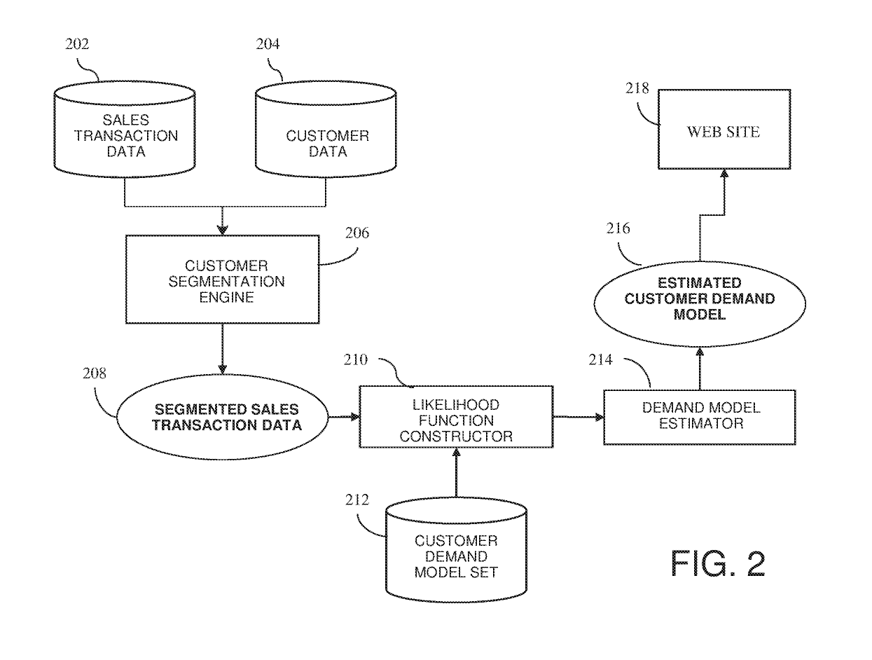

FIG. 2 is a diagram illustrating system architecture in one embodiment of the present disclosure. The system, for example, estimates a customer demand model with sales transaction data and customer data. Sales transaction data database 202 may store sales transaction and may include data such as the time of purchase of a product, the price of the purchased product, Sales transaction data may include customer ID, product ID, date of the sales, purchase price, Product group ID and manufacturer ID.

A customer data database 204 may store data describing the customers. Such data may be stored in an anonymous manner so as to protect customer privacy. The sales transaction data database 202 and the customer data database 204 may be stored on one or more storage devices.

A customer segmentation engine 206 may run on one or more hardware processors and segments customers into multiple groups based on customer features determined by analyzing the data stored in the customer data database 204 and sales prices stored in the sales transaction data database 202. For example, the customer segmentation engine 206 may select or identify customer features that characterize purchasing behaviors of users, for example, those that affect the sales price, using a predictive analytics technique, e.g., executing a predictive analytics technique. Examples of predictive analytics technique may include but are not limited to a regression model, a neutral network model and/or another machine learning model. Examples of such features may include, but are not limited to, tier level in loyalty program membership, age or age range/group, geography, past purchase histories, and click-stream information, total spending and purchase frequency. Other features that affect the sale price or user purchase behavior may be extracted or identified.

The customer segmentation engine 206 may cluster (segment) customers based on the identified features using a clustering algorithm, for example, the K-means clustering algorithm. In one embodiment, the customer segmentation engine 206 generates a plurality of segments. A segment may include criteria for segmenting new or existing customers (how to segment based on characteristics), for example, characteristics associated with the segment. The segment may also include actual existing customers that belong to the segment.

The customer segmentation engine 206 generates segmented sales transaction data 208 comprising sales transaction data from the sales transaction data database 202 segmented according the customer segments clustered based on the identified features. For example, the sales transaction data is segmented according to customers that performed the transaction in the sales transaction data.

Customer segments are used to segment sales transaction data. Segmented sales transaction data in one embodiment is used at 210 and 214 to estimate how customer of segment s(n) made transaction n, for example, paid p(n) in the likelihood function.

A likelihood function constructor 210 may run or execute on one or more hardware processors and chooses a type of customer demand model, for example, from a database storing a customer demand model set 212. The likelihood function constructor 210 constructs a likelihood function using sales transaction data and customer segment information 208. The segmented sales transaction data includes sales transaction data combined with segment of the customer who made each transaction.

In one embodiment, the likelihood function is determined based on the probability that each sales transaction belongs to the corresponding segment conditioned on the paid price, for example, shown in Equations (1) and (2) above.

A demand model estimator 214 computes the maximum likelihood estimator that maximizes the likelihood function. This component represents estimating the parameters of the likelihood function. The set of parameters depend on the chosen demand model. For example, the demand model estimator 214 estimates parameters of the chosen demand model that maximizes the likelihood function.

The likelihood function constructor and demand model estimator may be executed iteratively for cases in which there are more than two customer segments.

An estimated demand function (estimated customer demand model) 216 is generated. In one embodiment, the estimated demand function can be input to price optimization solutions. The estimated demand function includes a chosen demand model with estimated parameters for each customer segment, criteria (logic) for customer segmentation and estimated segment distribution. A user or automatic price optimization solution may execute the estimated demand function to determine optimal prices for products. The output (estimated demand function) can be automatically transferred to a price optimization engine.

For example, the estimated demand function that is output may be automatically transmitted to a price optimization engine, and automatically executed or invoked responsive to receiving a request for a price. For instance, a user visiting a product provider's website and navigating the web site's web pages (e.g., 218), may automatically trigger execution of a price optimization engine, which automatically requests and executes the estimated demand function for determining a price to provide to the user for a product the user is viewing on the web pages. For example, customer segment associated with the user may be determined and the estimated demand function may be executed for the customer segment to determine the price to provide to the user.

In one aspect, a web browser of the web site may automatically display a window or present a pop-up window on the web site's web page to enable the user to be able to view the price information determined according to the estimated demand function. In another aspect, a new web page may be automatically generated and displayed based on automatically executing the estimated demand function. For example, user interactions on the web site may be monitored and a web page or a display window automatically generated based on the monitored interactions.

In another aspect, the estimated demand function may be generated dynamically in real-time, for example, responsive to the user visiting the product provider's web site, and transmitted to a price optimization engine.

The likelihood function with the computed parameters provide a customer choice model without lost sales data. The method and system in one embodiment estimates customer choice model based on the fact that customers in different segments (for example, different membership levels in loyalty programs) have different reservation prices, and thus the proportion of customers in each segment changes at different price levels. The customer choice model estimation in one embodiment leverages customer segmentation, and a likelihood function in one embodiment is based on an event that is independent of types of information censoring, not requiring lost sales information.

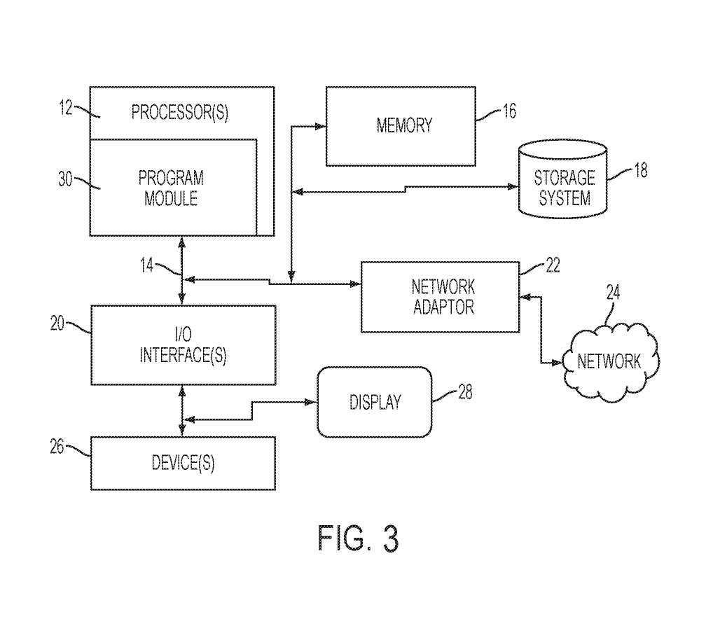

FIG. 3 illustrates a schematic of an example computer or processing system that may implement a segment based estimator system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 3 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 30 that performs the methods described herein. The module 30 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A system of constructing a segmentation-based demand model estimator executable on a computer, comprising:
a transaction data database;
a customer data database;
a hardware processor coupled to the transaction data database and the customer data database and comprising a customer segmentation engine;
the customer segmentation engine receiving transaction data from the transaction data database and customer data from the customer data database;
the customer segmentation engine executing a predictive modeling algorithm that determines customer features that characterize purchasing behavior from the customer data and the transaction data;
the customer segmentation engine executing a clustering algorithm that segments customers into multiple groups based on the customer features;
the hardware processor further comprising a likelihood function constructor that selects a customer demand model and constructs a likelihood function based on the transaction data and customer segment information determined from the multiple groups, the likelihood function determined based on probability that each sales transaction belongs to a segment conditioned on a paid price;
the hardware processor further comprising a demand model estimator that computes parameters of the likelihood function that maximizes the likelihood function.

2. The system of claim 1, wherein the predictive modeling algorithm determines customer features that characterize purchasing behavior from the customer data and sales prices in the transaction data, the customer features that affect the sales prices.

3. The system of claim 1, wherein the customer features comprise tier level in loyalty program membership, age group, geography, past purchase histories, click-stream information, total spending and purchase frequency.

4. The system of claim 1, wherein the predictive modeling algorithm comprises a regression algorithm.

5. The system of claim 1, wherein the predictive modeling algorithm comprises a neural network model trained by machine learning.

6. The system of claim 1, wherein the clustering algorithm comprises K-means clustering algorithm.

7. The system of claim 1, wherein the customer demand model comprises a logistic demand model.

8. The system of claim 1, wherein the customer demand model comprises a linear demand model.

9. A method of constructing a segmentation-based demand model estimator executable on a computer, the method performed by at least on hardware processor, the method comprising:
receiving transaction data from a transaction data database and customer data from a customer data database;
executing a predictive modeling algorithm that determines customer features that characterize purchasing behavior from the customer data and the transaction data;
executing a clustering algorithm that segments customers into multiple groups based on the customer features;
selecting a customer demand model;
constructing a likelihood function based on the customer demand model, the transaction data and customer segment information determined from the multiple groups, the likelihood function determined based on probability that each sales transaction belongs to a segment conditioned on a paid price;
determining parameter values of the likelihood function that maximizes the likelihood function; and
executing the likelihood function with the determined parameter values.

10. The method of claim 9, wherein the predictive modeling algorithm determines customer features that characterize purchasing behavior from the customer data and sales prices in the transaction data, the customer features that affect the sales prices.

11. The method of claim 9, wherein the customer features comprise tier level in loyalty program membership, age group, geography, past purchase histories, click-stream information, total spending and purchase frequency.

12. The method of claim 9, wherein the predictive modeling algorithm comprises a regression algorithm.

13. The method of claim 9, wherein the predictive modeling algorithm comprises a neural network model.

14. The method of claim 9, wherein the clustering algorithm comprises K-means clustering algorithm.

15. The method of claim 9, wherein the customer demand model comprises a logistic demand model.

16. The method of claim 9, wherein the customer demand model comprises a linear demand model.

17. A computer readable storage medium storing a program of instructions executable by a machine to perform a method of constructing a segmentation-based demand model estimator executable on a computer, the method performed by at least on hardware processor, the method comprising:
receiving transaction data from a transaction data database and customer data from a customer data database;
executing a predictive modeling algorithm that determines customer features that characterize purchasing behavior from the customer data and the transaction data;
executing a clustering algorithm that segments customers into multiple groups based on the customer features;
selecting a customer demand model;
constructing a likelihood function based on the customer demand model, the transaction data and customer segment information determined from the multiple groups, the likelihood function determined based on probability that each sales transaction belongs to a segment conditioned on a paid price;
determining parameter values of the likelihood function that maximizes the likelihood function; and
executing the likelihood function with the determined parameter values.

18. The computer readable storage medium of claim 17, wherein the customer features comprise tier level in loyalty program membership, age group, geography, past purchase histories, click-stream information, total spending and purchase frequency.

19. The computer readable storage medium of claim 17, wherein the predictive modeling algorithm comprises a regression algorithm.

20. The computer readable storage medium of claim 17, wherein the predictive modeling algorithm comprises a neural network model.
